(19) United States
(12) Patent Application Publication
(10) Pub. No.: US 2012/0268079 A1
(43) Pub. Date: Oct. 25, 2012

(54) DISCHARGE CONTROL CIRCUIT

(75) Inventor: Yasushi NAKAMURA, Nishio (JP)

(73) Assignee: AISIN AW CO., LTD., Anjo-shi (JP)

(21) Appl. No.: 13/441,409

(22) Filed: Apr. 6, 2012

(30) Foreign Application Priority Data
Apr. 25, 2011 (JP) 2011-096839

(51) Int. Cl. H02J 7/00

(52) U.S. Cl. 320/166

(57) ABSTRACT

A discharge control circuit that allows an electric charge accumulated in a smoothing capacitor, which is interposed between a main power source that supplies DC power to an electric circuit and the electric circuit, to be discharged when connection between the main power source and the electric circuit is interrupted, includes a series resistor section formed by connecting a first resistor and a second resistor in series with each other and connected in parallel with the smoothing capacitor; and a switch connected in parallel with the first resistor, controlled to a non-conductive state when connection between the main power source and the electric circuit is maintained, and controlled to a conductive state to short-circuit both ends of the first resistor when connection between the main power source and the electric circuit is interrupted.

### INCORPORATION BY REFERENCE

The disclosure of Japanese Patent Application No. 2011-096839 filed on April 25, 2011 including the specification, drawings and abstract is incorporated herein by reference in its entirety.

### BACKGROUND OF THE INVENTION

The present invention relates to a discharge control circuit that allows an electric charge accumulated in a smoothing capacitor to be discharged.

### DESCRIPTION OF THE RELATED ART

An electric circuit is supplied with electric power for driving the circuit to perform a predetermined function. If the electric power is not stable, operation of the circuit also becomes unstable. Thus, in many cases, a smoothing capacitor is provided between a power source that supplies the electric power and the electric circuit to stabilize the electric power. An electric charge is accumulated in the smoothing capacitor in case of an interruption of the supply of electric power from the power source. The electric charge gradually decreases through self discharge. In the case where the electric circuit operates at a relatively high voltage of 50 V or more and with a consumption current of several amperes or more, however, the smoothing capacitor should have an accordingly higher capacitance. Thus, it takes a longer time for the electric charge to decrease through self discharge. In consideration of the possibility that the electric circuit is inspected after the interruption of the supply of electric power from the power source, the electric charge in the smoothing capacitor is preferably discharged rapidly. From such a viewpoint, a discharge resistance is occasionally provided in parallel with the smoothing capacitor to allow the electric charge in the smoothing capacitor to be rapidly discharged. As a matter of course, as the resistance value of the discharge resistance is smaller, a shorter time is required for the discharge. As the resistance value of the discharge resistance is smaller, however, the discharge resistance consumes a larger amount of electric power (which deteriorates efficiency) when supplied with electric power, and has larger outer dimensions. Therefore, a discharge resistance that requires a relatively long discharge time is used in many systems according to the related art (such discharge is referred to as constant discharge). From the viewpoint of improving inspectability and safety, however, it has become necessary to separately add a rapid discharge system that functions only when the electric power is interrupted.

Japanese Patent Application Publication No. 6-276610 (JP 6-276610 A) discloses a technique for controlling charge and discharge of a smoothing capacitor using a mechanical relay that functions as a switch (seventeenth to nineteenth paragraphs, FIG. 1, etc.). According to the technique, when a smoothing capacitor (C) is to be charged, a mechanical relay (Ry3) disconnects a discharge resistance (R1) so that an electric charge is supplied to the smoothing capacitor (C) via a current limiting resistance (charge resistance (R2)) that suppresses an in-rush current into the smoothing capacitor (C). The charge resistance (R2) is disconnected by a mechanical relay (Ry2) except when power is turned on. When the smoothing capacitor (C) is to be discharged, on the other hand, the mechanical relay (Ry3) connects a discharge resistance (R1) in parallel with the smoothing capacitor (C) so that the electric charge accumulated in the smoothing capacitor (C) is discharged via the discharge resistance (R1).

Examples of an element that functions as a switch in such a discharge circuit include, besides the mechanical relay, semiconductor switching elements that use a semiconductor such as a solid-state relay and an FET. Nowadays, such switches that use a semiconductor are used frequently from the viewpoint of ease of handling and cost. When the switch is open, a voltage is applied between its contact points. For a mechanical relay, the physical distance between the contact points serves as an insulation distance to provide a resistance to voltage. For a switch that uses a semiconductor, the reverse breakdown voltage of a PN junction, for example, provides a resistance to voltage. Here, in the case where the operating voltage of the electric circuit which is supplied with electric power from the power source is a relatively high voltage of 50 V or more, for example, the voltage across the smoothing capacitor is also a relatively high voltage of 50 V or more. If the electric circuit is a drive circuit for a rotary electric machine or the like, the operating voltage may be as high as 200 V or more. The voltage across the discharge resistance connected in parallel with the smoothing capacitor is equivalent to the voltage across the smoothing capacitor. Thus, the same voltage is applied between the contact points of the switch which disconnects the discharge resistance when the switch is in the off state. This requires the switch to provide high withstand voltage characteristics. Semiconductor switches having such high withstand voltage characteristics may be large or costly.

### SUMMARY OF THE INVENTION

In view of the foregoing background, it is desirable to provide a discharge control circuit which reduces power consumption when electric power is supplied and enables an electric charge accumulated in a smoothing capacitor to be rapidly discharged when a power source is disconnected, and in which the withstand voltage of a switch that controls discharge is suppressed to be low.

In view of the foregoing issue, a discharge control circuit according to an aspect of the present invention allows an electric charge accumulated in a smoothing capacitor, which is interposed between a main power source that supplies DC power to an electric circuit and the electric circuit, to be discharged when connection between the main power source and the electric circuit is interrupted, and the discharge control circuit includes:
a series resistor section formed by connecting a first resistor and a second resistor in series with each other and connected in parallel with the smoothing capacitor; and
a switch connected in parallel with the first resistor, controlled to a non-conductive state when connection between the main power source and the electric circuit is maintained, and controlled to a conductive state to short-circuit both ends of the first resistor when connection between the main power source and the electric circuit is interrupted.

According to the aspect, a voltage obtained by dividing the voltage between the terminals of the smoothing capacitor by the first resistor and the second resistor is applied across the switch connected in parallel with the first resistor. That is, a voltage lower than the voltage between the terminals of the smoothing capacitor is applied across the switch. This allows utilization of a switch having an electrical characteristic of a withstand voltage lower than the voltage between the terminals of the smoothing capacitor. When electric power is supplied, the respective resistance values of the first resistor and the second resistor connected in series with each other are summed to provide a combined resistance, and thus power consumption is low. When the electric charge in the smoothing capacitor is to be discharged, on the other hand, both ends of the first resistor are short-circuited by the switch so that only the second resistor provides a discharge resistance, which allows discharge from the smoothing capacitor with a small time constant. Thus, according to the aspect, it is possible to obtain a discharge control circuit which reduces power consumption when electric power is supplied and enables an electric charge accumulated in the smoothing capacitor to be rapidly discharged when the power source is disconnected, and in which the withstand voltage of the switch that controls discharge is suppressed to be low.

Here, in the discharge control circuit according to the aspect, a resistance value of the second resistor may be set to a value less than a resistance value of the first resistor. The configuration reduces power consumption during normal electric power supply, and enables quick discharge.

In the discharge control circuit according to the aspect, in addition, the first resistor and the switch may be connected to a positive electrode side of the main power source. According to the configuration, even if a ground fault is caused in the second resistor, the first resistor is connected in parallel with the smoothing capacitor if the switch is in the open state. Thus, the function as the discharge resistance is maintained by the first resistor if the first resistor and the switch are connected to the positive electrode side of the main power source.

In order to facilitate heat radiation from the second resistor, through which a large current flows during rapid discharge to produce much heat, the discharge control circuit is occasionally configured such that the second resistor is disposed outside a substrate on which the first resistor and the switch are mounted. Such a configuration can be implemented by connecting a connector assembly including the second resistor to a connector housing mounted on the substrate, for example. In this event, a terminal on the negative electrode side of the main power source and a terminal for the first resistor and the switch may be exposed to the outside of the substrate via terminals of the connector housing. Thus, according to the configuration described above, the positive electrode of the main power source, which may carry a high voltage, is confined within the substrate, which facilitates securing insulation.

If a ground fault is caused in the second resistor for rapid discharge from the smoothing capacitor in the case where the first resistor and the switch are connected to the positive electrode side of the main power source, the function as the discharge resistance is lost because of the ground fault. However, the ground fault can be detected by monitoring the voltage of the connection point between the first resistor and the second resistor, for example. That is, in the case where no ground fault is caused in the second resistor, the voltage of the connection point has a value obtained by dividing the voltage across the smoothing capacitor (voltage of the main power source) by the first resistor and the second resistor, In the case where a ground fault is caused in the second resistor, on the other hand, the voltage of the connection point becomes the ground voltage (voltage on the negative electrode side of the main power source). Thus, even if a ground fault is caused in the second resistor during steady operation of the electric circuit, the discharge control circuit can detect the ground fault by monitoring the voltage of the connection point between the first resistor and the second resistor. Then, the discharge control circuit can prevent an over-current from flowing through the switch to prevent damage to the switch by not controlling the switch to the on state, and enables an electric charge in the smoothing capacitor to be discharged at least via the first resistor. In the case where a short-circuit fault is caused in the switch as a different type of fault, the first resistor is short-circuited at all times so that the voltage of the connection point between the first resistor and the second resistor is the voltage on the positive electrode side of the main power source. Thus, a short-circuit fault of the switch and a short-circuit fault of the first resistor can also be detected by monitoring the voltage of the connection point.

Specifically, as a preferred aspect of the present invention, the discharge control circuit may further include: a first voltage sensor that detects a voltage of a terminal on the positive electrode side of the series resistor section; a second voltage sensor that detects a voltage of a connection point between the first resistor and the second resistor; and a fault diagnosis section that diagnoses a fault of the series resistor section and the switch on the basis of results of detection performed by the first voltage sensor and results of detection performed by the second voltage sensor. Also in the case where the first resistor and the switch are connected to the negative electrode side, rather than to the positive electrode side, of the main power source, a fault of the discharge control circuit can be detected by providing the first voltage sensor, the second voltage sensor, and the fault diagnosis section. For example, in the case where a ground fault is caused in the first resistor, the voltage of the connection point becomes the ground voltage (voltage on the negative electrode side of the main power source), which allows detection of the ground fault.

### BRIEF DESCRIPTION OF THE DRAWINGS

FIG. 1 is a circuit block diagram schematically showing an example of the configuration of a discharge control circuit;

FIG. 2 is a circuit block diagram schematically showing an example of the configuration of a discharge control circuit with a diagnosis function;

FIG. 3 is a circuit block diagram showing an example of a discharge control circuit according to a comparative example;

FIG. 4 is a circuit block diagram showing an example of the discharge control circuit of FIG. 3 to which a diagnosis function has been added;

FIG. 5 is a circuit block diagram showing an example of a discharge control circuit according to another comparative example to which a diagnosis function has been added; and

FIG. 6 is a circuit block diagram schematically showing another example of the configuration of a discharge control circuit.

### DETAILED DESCRIPTION OF THE EMBODIMENTS

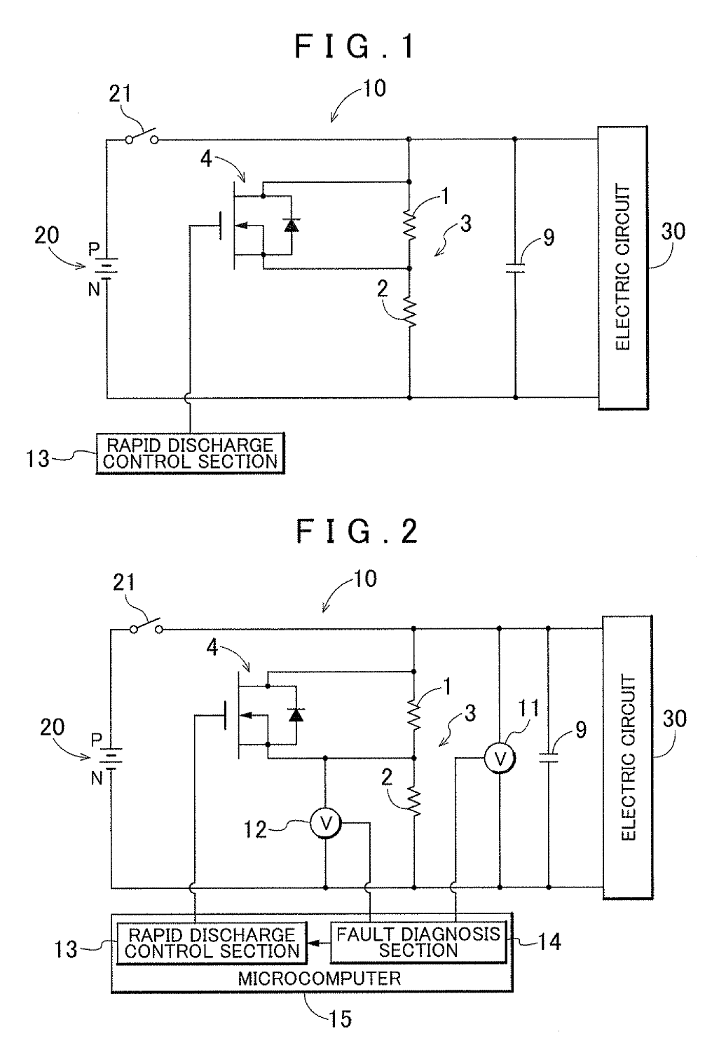

An embodiment of the present invention will be described below with reference to the drawings. As shown in FIG. 1, a discharge control circuit 10 is a circuit that allows an electric charge accumulated in a smoothing capacitor 9, which is interposed between a main power source 20 that supplies DC power to an electric circuit 30 and the electric circuit 30, to be discharged when connection between the main power source 20 and the electric circuit 30 is interrupted. Various circuits may be used as the electric circuit 30. For example, the electric circuit 30 may be a power-system circuit such as an inverter or a converter that operates at a relatively high power-source voltage (50 V or more) while consuming a large current of several amperes or more. In such a electric circuit 30 is connected to the main power source 20 via a system main relay (SMR) 21 etc. In the case where the SMR 21 is closed, electric power is supplied from the main power source 20 to the electric circuit 30. In the case where the SMR 21 is open, connection between the main power source 20 and the electric circuit 30 is interrupted. In the case where the electric circuit 30 is connected to an electric generator and the main power source 20 is a chargeable battery or the like, electric power may be supplied from the electric circuit 30 to the main power source 20 to charge the main power source 20.

When the electric power for driving the electric circuit 30 is not stable, operation of the electric circuit 30 also becomes unstable. Thus, in many cases, the smoothing capacitor 9 is provided between the main power source 20 which supplies electric power and the electric circuit 30 to stabilize the electric power. An electric charge remains in the smoothing capacitor 9 even in the case where the SMR 21 is opened to interrupt the supply of electric power from the main power source 20. The electric charge gradually decreases through self discharge. In the case where the electric circuit 30 is a power-system circuit discussed above, however, the smoothing capacitor 9 should have an accordingly higher capacitance. Thus, it takes a longer time for the electric charge to decrease through self discharge. In consideration of a case where the electric circuit 30 is inspected after the interruption of the supply of electric power from the main power source 20, the electric charge in the smoothing capacitor 9 is preferably discharged rapidly. From such a viewpoint, a resistor is provided in parallel with the smoothing capacitor 9 to rapidly discharge the electric charge in the smoothing capacitor 9.

In the embodiment, a series resistor section 3 formed by connecting a first resistor 1 and a second resistor 2 in series with each other is connected in parallel with the smoothing capacitor 9. When the SMR 21 is turned from the open state to the closed state, the smoothing capacitor 9 is charged with a transient response (charge characteristics) corresponding to a time constant determined by the combined resistance of the series resistor section 3 and the capacitance of the smoothing capacitor 9. When charge is completed to establish a steady state, the voltage across the smoothing capacitor 9 becomes a voltage P-N between the positive and negative electrodes of the main power source 20. Here, if the negative electrode N of the main power source 20 is grounded (=0 [V]), the voltage across the smoothing capacitor 9 can be represented as P [V].

When the SMR 21 is turned from the closed state to the open state, on the other hand, the electric charge accumulated in the smoothing capacitor 9 is discharged via the series resistor section 3. In this event, as the resistance value of the series resistor section 3 is smaller, the current is larger, and a shorter time is required for the discharge. If the resistance value of the series resistor section 3 is small, however, power consumption during normal times is increased. Thus, the discharge control circuit 10 according to the embodiment is configured such that the resistance value of the series resistor section 3 can be changed between when charge is started and during steady operation and during discharge. Specifically, when charge is started and during steady operation, the resistance value of the series resistor section 3 is a resistance value (sum) obtained by combining the respective resistance values of the first resistor 1 and the second resistor 2 connected in series with each other. During discharge, on the other hand, the resistance value of the series resistor section 3 is the resistance value of the second resistor 2. Switching between such resistance values is performed as follows.

In the embodiment, as shown in FIG. 1, the first resistor 1 is connected to the positive electrode P side of the main power source 20, and the second resistor 2 is connected to the negative electrode N side of the main power source 20. In other words, the first resistor 1 is a resistor on the high side of the series resistor section 3, and the second resistor 2 is a resistor on the low side of the series resistor 3 section. A MOSFET 4 that functions as a switch is connected in parallel with the first resistor 1. The MOSFET 4 is subjected to switching control performed by a rapid discharge control section 13 formed by a microcomputer or the like, for example. Specifically, when connection between the main power source 20 and the electric circuit 30 is maintained (the SMR 21 is in the closed state), the MOSFET 4 is controlled to the non-conductive state (off state). When connection between the main power source 20 and the electric circuit 30 is interrupted (the SMR 21 is in the open state), meanwhile, the MOSFET 4 is controlled to the conductive state (on state).

When the MOSFET 4 is controlled to the conductive state, both ends of the first resistor 1 are connected to each other via a very low on resistance. The on resistance is ignorably low relative to the resistance value of the first resistor 1, and both ends of the first resistor 1 are substantially short-circuited. With both ends of the first resistor 1 short-circuited via the MOSFET 4, the resistance value of the series resistor section 3 becomes substantially the same as the resistance value of the second resistor 2. With the SMR 21 in the open state, no electric charge is supplied from the main power source 20 to the smoothing capacitor 9, and the electric charge accumulated in the smoothing capacitor 9 is discharged via the series resistor section 3. Since the series resistor section 3 is formed by only the second resistor 2 at this time, the resistance value of the series resistor section 3 is smaller than that during charge, and the time constant is also smaller. Thus, discharge from the smoothing capacitor 9 is completed immediately.

Here, the resistance value of the second resistor 2 is preferably set to a value smaller than that of the first resistor 1. During discharge, the resistance value of the series resistor section 3 can be made small compared to that during charge or during steady times, and the time constant can also be made small, which allows discharge from the smoothing capacitor 9 to be completed further more immediately. As a matter of course, the first resistor 1 and the second resistor 2 may be resistors having the same rated resistance value, or the resistance value of the first resistor 1 may be smaller than that of the second resistor 2. That is, the resistance value of the second resistor 2 is smaller than the sum of the respective resistance values of the two resistors, and thus the resistance value of the series resistor section 3 can be changed to a small value by substantially short-circuiting both ends of the first resistor 1 via the MOSFET 4.

In order to facilitate heat radiation from the second resistor 2, through which a large current flows during rapid discharge to produce much heat compared to the first resistor 1, the discharge control circuit 10 is preferably configured such that the second resistor 2 is disposed outside a substrate on which the first resistor 1 and the MOSFET 4 are mounted. The second resistor 2 is preferably disposed outside the substrate also for replacement of the second resistor 2 because of wear due to heat generation or for regular maintenance. Specifically, the second resistor 2 is preferably mounted between the negative electrode N side and the first resistor 1 and the MOSFET 4 connected in parallel with each other by connecting a connector assembly including the second resistor 2 to a connector housing mounted on the substrate. With the second resistor 2 disposed outside the substrate, heat radiation from the second resistor 2 can be achieved with a high degree of freedom, by simply cooling with air, adding a heat sink, or the like. This also allows the second resistor 2 to be replaced easily, by replacing the connector assembly.

In the discharge control circuit 10 illustrated in FIG. 1, as discussed above, the first resistor 1 and the MOSFET 4 (switch) are disposed on the high side of the series resistor section 3. Therefore, a terminal on the negative electrode N side of the main power source 20 and a terminal opposite the positive electrode P side of the first resistor 1 and the MOSFET 4 are partially exposed to the outside of the substrate via the connector housing. Thus, a terminal on the positive electrode P side of the main power source 20 can be mounted within the substrate with high insulation with no part of the terminal exposed to the outside of the substrate. In the case where the main power source 20 has a high voltage of 50 V or more, for example, particularly high insulation is preferably provided on the positive electrode P side in consideration of safety. Such a suitable configuration can be achieved easily by disposing the first resistor 1 and the MOSFET 4 on the high side.

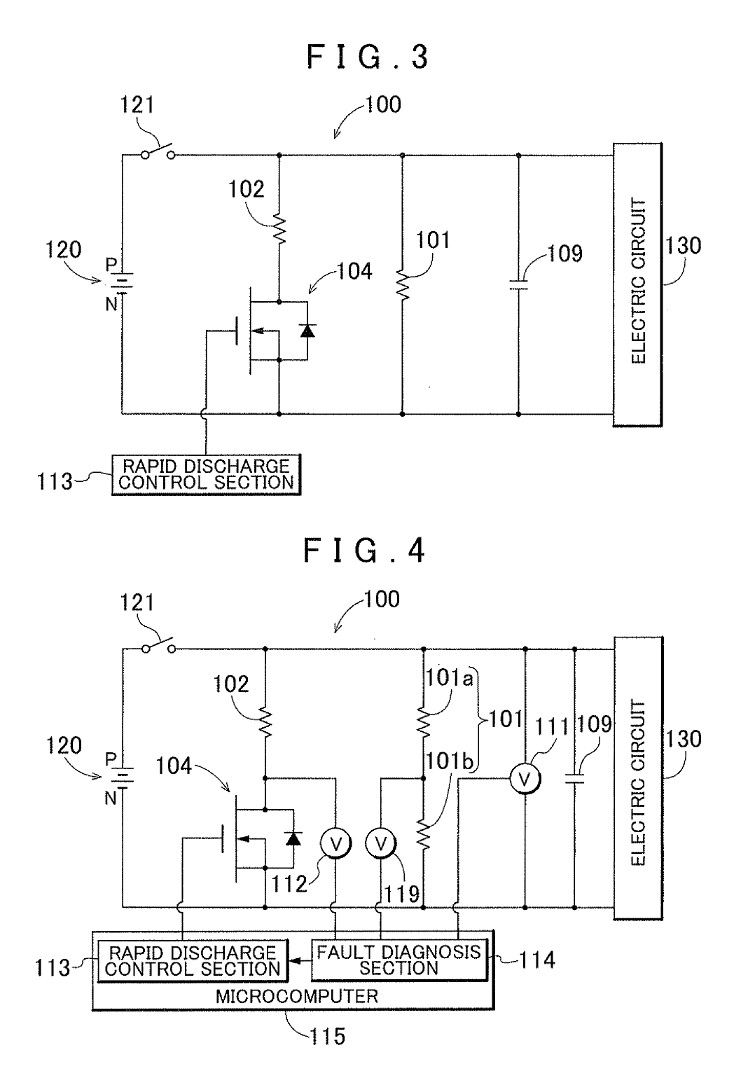

FIG. 3 shows a discharge control circuit 100 according to a comparative example for comparison with the discharge control circuit 10 according to the embodiment. In the discharge control circuit 100, a first resistor 101, which functions during steady operation of an electric circuit 130 and during discharge from a smoothing capacitor 109, and a second resistor 102, which functions during discharge from the smoothing capacitor 109, are connected in parallel with the smoothing capacitor 109. In the discharge control circuit 100, when a MOSFET 104 is in the off state, the voltage P [V] between the positive and negative electrodes of a main power source 120 is applied between the drain and the source of the MOSFET 104. In the embodiment illustrated in FIG. 1, in contrast, when the MOSFET 4 is in the off state, a voltage applied between the drain and the source of the MOSFET 4 is obtained by dividing the voltage P [V] by the first resistor 1 and the second resistor 2, and is thus lower than P [V].

Specifically, defining the resistance value of the first resistor 1 as R1 and the resistance value of the second resistor 2 as R2, the drain-source voltage is calculated as P×(R1/(R1+R2)) [V]. That is, in the discharge control circuit 10 according to the embodiment, the voltage across the MOSFET 4 can be suppressed to be low, which allows use of an element with a low withstand voltage to suppress an increase in scale and cost of the apparatus. In the case where the resistance value R2 of the second resistor 2 is smaller than the resistance value R1 of the first resistor 1 as discussed above, for example R1=45 [kΩ], R2=5 [kΩ], and P=100 [V], the drain-source voltage of the MOSFET 4 is 90 [V]. The drain-source voltage of the MOSFET 104 in the discharge control circuit 100 shown in FIG. 3 is P=100 [V]. Thus, an element with a lower withstand voltage can be used as the MOSFET 4 in the discharge control circuit 10 according to the embodiment.

The discharge control circuit 10 according to the embodiment can be provided with an excellent diagnosis function. FIG. 2 shows an example in which a diagnosis circuit is added to the discharge control circuit 10 of FIG. 1. As shown in FIG. 2, the discharge control circuit 10 includes a first voltage sensor 11 that detects the voltage of the terminal on the positive electrode P side of the series resistor section 3, and a second voltage sensor 12 that detects the voltage of the connection point between the first resistor 1 and the second resistor 2. The results of detection performed by the first voltage sensor 11 and the second voltage sensor 12 are transferred to a fault diagnosis section 14, which is formed using a microcomputer 15 as with the rapid discharge control section 13. The fault diagnosis section 14 diagnoses a fault of the series resistor section 3 and the MOSFET 4 on the basis of the results of detection performed by the first voltage sensor 11 and the results of detection performed by the second voltage sensor 12.

(Diagnosis Conditions/SMR: Closed (During Steady Operation))

When the SMR 21 is in the closed state, the fault diagnosis section 14 can compute the voltage at the connection point between the first resistor 1 and the second resistor 2 on the basis of the results of detection performed by the first voltage sensor 11 since the respective resistance values of the first resistor 1 and the second resistor 2 are known. Then, it can be determined whether or not the series resistor section 3 (including the MOSFET 4) is normal on the basis of the results of the computation and the results of detection performed by the second voltage sensor 12. For example, if the terminal on the negative electrode N side of the first resistor 1 or the MOSFET 4 (or the terminal on the positive electrode P side of the second resistor 2) is short-circuited with the positive electrode P, the second voltage sensor 12 detects a value of P [V]. In this case, the fault diagnosis section 14 can determine that a fault (supply fault) is caused in the series resistor section 3. If the terminal on the negative electrode N side of the first resistor 1 or the MOSFET 4 (the terminal on the positive electrode P side of the second resistor 2) is short-circuited with the negative electrode N, the second voltage sensor 12 detects a value of 0 [V]. In this case, the fault diagnosis section 14 can determine that a fault (ground fault) is caused in the series resistor section 3.

In the case where the first resistor 1 is open with a wire breakage caused in the first resistor 1, with a terminal of the first resistor 1 disconnected from the substrate, or the like, the second voltage sensor 12 detects a value of 0 [V]. Thus, the fault diagnosis section 14 can determine that a fault (open fault) is caused in the first resistor 1. In the case where the second resistor 2 is open with a wire breakage caused in the second resistor 2, with a terminal of the second resistor 2 disconnected from the substrate, or the like, the second voltage sensor 12 detects a value of P [V]. Thus, the fault diagnosis section 14 can determine that a fault (open fault) is caused in the second resistor 2. The fault diagnosis section 14 does not necessarily specify the type of a fault, and may be configured to only detect the presence or absence of a fault.

In the case where the second voltage sensor 12 detects a value of P×(R1/(R1+R2)) [V], rather than P, even if the rapid discharge control section 13 controls the MOSFET 4 to the on state when the SMR 21 is in the closed state, the fault diagnosis section 14 can determine that a fault is caused in the MOSFET 4. Thus, it is possible to diagnose a fault of the series resistor section 3, including the MOSFET 4 serving as a switch, when the SMR 21 is in the closed state, that is, while the electric circuit 30 is operating steadily. Therefore, the reliability of the discharge control circuit 10 is improved.

(Diagnosis Conditions/SMR: Open (During Discharge Operation))

When the SMR 21 is in the open state, on the other hand, the fault diagnosis section 14 can diagnose a fault of the discharge control circuit 10, including the discharge characteristics of the smoothing capacitor 9. For example, the fault diagnosis section 14 can acquire the discharge characteristics during normal discharge, rather than during rapid discharge, by monitoring respective values detected by the first voltage sensor 11 and the second voltage sensor 12 at constant sampling intervals with the MOSFET 4 kept in the off state. It is possible to diagnose a fault of the discharge control circuit 10, including the discharge characteristics, by storing a reference value of the discharge characteristics in a program memory or a parameter memory (not shown) of the microcomputer 15 and comparing the acquired discharge characteristics with the reference value. The microcomputer 15 can also acquire the discharge characteristics during rapid discharge by monitoring respective values detected by the first voltage sensor 11 and the second voltage sensor 12 at constant sampling intervals with the MOSFET 4 in the on state. Then, it is likewise possible to diagnose a fault of the discharge control circuit 10, including the discharge characteristics during rapid discharge, by comparing the acquired discharge characteristics with a reference value of the discharge characteristics during rapid discharge stored in the program memory or the parameter memory of the microcomputer 15.

(Diagnosis of Discharge Control Circuit According to Comparative Example/Diagnosis Conditions/SMR: Open (During Discharge Operation))

In the discharge control circuit 100 according to the comparative example shown in FIG. 3, it is possible to diagnose a fault including the discharge characteristics in the same manner as described above with an SMR 121 in the open state. In this case, as shown in FIG. 4, the discharge control circuit 100 includes a first voltage sensor 111 that detects the voltage of the terminal on the positive electrode side of the first resistor 101, and a second voltage sensor 112 that detects the voltage of the connection point between the second resistor 102 and the MOSFET 104. A fault diagnosis section 114 can diagnose a fault of the discharge control circuit 100 on the basis of the results of detection performed by the first voltage sensor 111 and the second voltage sensor 112. When the MOSFET 104 is in the off state, the discharge characteristics during normal discharge, rather than during rapid discharge, can be acquired in the same manner as described above. When the MOSFET 104 is in the on state, meanwhile, the discharge characteristics during rapid discharge can be acquired in the same manner as described above. A microcomputer 115 can compare the acquired discharge characteristics with a reference value in the same manner as described above. Although not described in detail, a fault such as a ground fault of the terminal of the second resistor 102 on the negative electrode N side can also be detected.

(Diagnosis of Discharge Control Circuit According to Comparative Example/Diagnosis Conditions/SMR: Closed (During Steady Operation))

In the case where the SMR 121 is in the closed state, the discharge control circuit 100 cannot acquire the discharge characteristics as described above, or detect an open fault due to a wire breakage in the first resistor 101. In order to detect faults such as those detected in the discharge control circuit 10 illustrated in FIG. 2, it is necessary that the discharge control circuit 100 should be configured at least as shown in FIG. 4.

Specifically, the first resistor 101 is formed by two resistors 101a and 101b connected in series with each other. Then, a third voltage sensor 119 is further provided at the connection point between the resistor 101a and the resistor 101b, and the results of detection performed by the third voltage sensor 119 are transferred to the fault diagnosis section 114. The fault diagnosis section 114 diagnoses a fault of the discharge control circuit 100 on the basis of the results of detection performed by the first voltage sensor 111, the second voltage sensor 112, and the third voltage sensor 119. Although not described in detail, if the first resistor 101 (101a and 101b) is normal, the first voltage sensor detects P [V]. In addition, the third voltage sensor 119 detects a value obtained by dividing P [V] by the first resistors 101a and 101b which have known resistance values. If an open fault is caused in any of the first resistors 101a and 101b, the results of detection performed by the third voltage sensor 119 differ from an expected value (reference value). This allows determination of a fault of the first resistor 101.

As is clear from a comparison between the discharge control circuit 10 shown in FIG. 2 and the discharge control circuit 100 shown in FIG. 4, the discharge control circuit 100 according to the comparative example has an increased circuit scale with the first resistor 101 divided into two and with the third voltage sensor 119 provided. Thus, the discharge control circuit 10 according to the embodiment of the present invention illustrated in FIG. 2 can achieve the same function with a smaller configuration, and thus is more preferable.

(Another Example of Discharge Control Circuit According to Comparative Example)

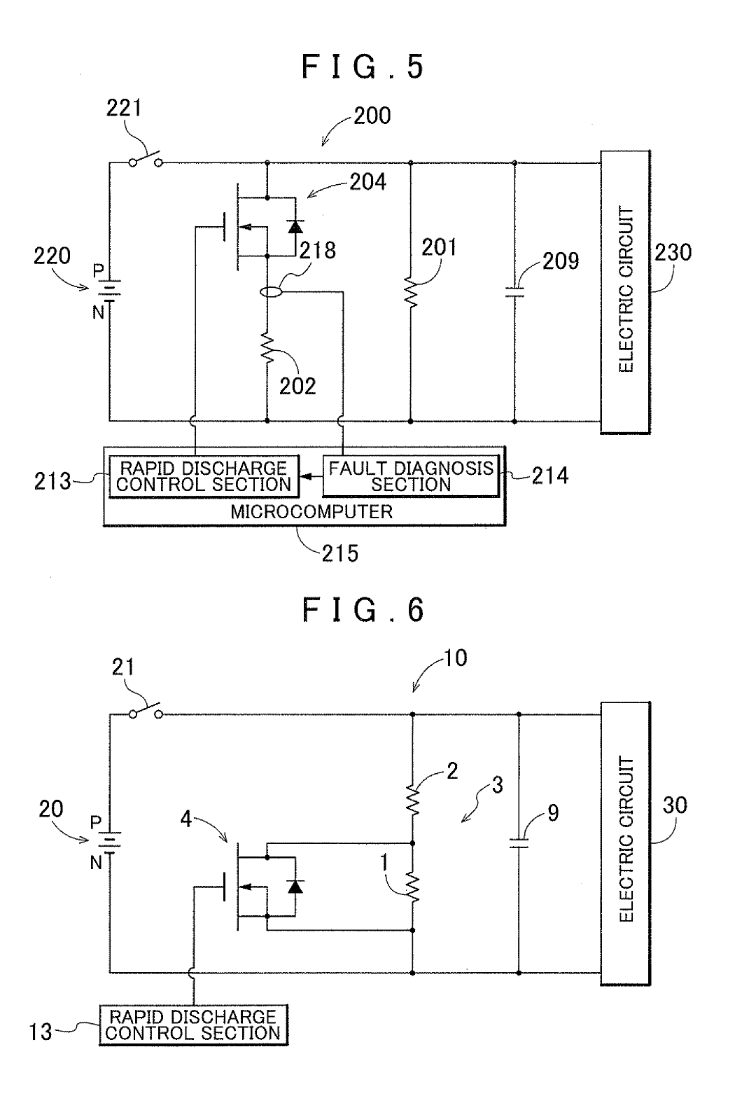

The discharge control circuit 100 according to the comparative example may be formed into a discharge control circuit 200 shown in FIG. 5 by relocating the MOSFET 104 from the low side to the high side. In this case, a current sensor 218 is preferably provided as a sensor that provides a fault diagnosis section 214 with detected information. The current sensor 218 detects an over-current that flows when a MOSFET 204 is turned on with a ground fault caused on the positive electrode P side of a second resistor 202. However, the discharge control circuit 200 cannot make a diagnosis for a rapid discharge function, including the state of the second resistor 202, when the MOSFET 204 is in the off state. In addition, the discharge control circuit 200 cannot detect an open fault of the second resistor 202, either. In contrast, as discussed above, the discharge control circuit 10 according to the embodiment of the present invention can detect both a ground fault and an open fault of the second resistor 2 with the MOSFET 4 in the off state. The discharge control circuit 10 does not have a function to detect such faults with the MOSFET 4 turned on. However, the discharge control circuit 10 can detect a ground fault of the second resistor 2 with the MOSFET 4 turned off, and thus can avoid a short circuit unless the MOSFET 4 is controlled to the on state. That is, it is possible to prevent an over-current from flowing through the MOSFET 4 to prevent damage to the MOSFET 4, and to allow the electric charge remaining in the smoothing capacitor 9 to be discharged at least via the first resistor 1.

### Other Embodiments

Other embodiments of the present invention will be described. The configuration of each embodiment described below is not limited to its independent application, and may be applied in combination with the configuration of other embodiments unless any contradiction occurs.

(1) In the embodiment of the present invention, as described with reference to FIGS. 1 and 2, the first resistor 1 and the MOSFET 4 (switch) are disposed on the high side of the series resistor section 3. However, the present invention is not limited to such a configuration. For example, as shown in FIG. 6, the first resistor 1 and the MOSFET 4 may be disposed on the low side of the series resistor section 3. The discharge control circuit 10 with such a configuration may be configured to have a fault diagnosis function as with the discharge control circuit 10 illustrated in FIG. 2.

(2) In the embodiment described above, a MOSFET is used as a switch disposed in parallel with the first resistor 1. However, the present invention is not limited thereto. A bipolar transistor, a solid-state relay, a mechanical relay, or the like may also be used as the switch.

The present invention is applicable to a discharge control circuit that allows an electric charge accumulated in a smoothing capacitor to be discharged. In particular, the present invention is suitably applied to a discharge control circuit that allows effective discharge from a smoothing capacitor for a power-system electric circuit that operates at a high voltage and with a large current. Examples of such an electric circuit include an inverter that drives a rotary electric machine and a DC-DC converter.

What is claimed is:

1. A discharge control circuit that allows an electric charge accumulated in a smoothing capacitor, which is interposed between a main power source that supplies DC power to an electric circuit and the electric circuit, to be discharged when connection between the main power source and the electric circuit is interrupted, the discharge control circuit comprising:
a series resistor section formed by connecting a first resistor and a second resistor in series with each other and connected in parallel with the smoothing capacitor; and
a switch connected in parallel with the first resistor, controlled to a non-conductive state when connection between the main power source and the electric circuit is maintained, and controlled to a conductive state to short-circuit both ends of the first resistor when connection between the main power source and the electric circuit is interrupted.

2. The discharge control circuit according to claim 1, wherein
a resistance value of the second resistor is set to a value less than a resistance value of the first resistor.

3. The discharge control circuit according to claim 2, wherein
the first resistor and the switch are connected to a positive electrode side of the main power source.

4. The discharge control circuit according to claim 3, further comprising:
a first voltage sensor that detects a voltage of a terminal on the positive electrode side of the series resistor section;
a second voltage sensor that detects a voltage of a connection point between the first resistor and the second resistor; and
a fault diagnosis section that diagnoses a fault of the series resistor section and the switch on the basis of results of detection performed by the first voltage sensor and results of detection performed by the second voltage sensor.

5. The discharge control circuit according to claim 1, wherein
the first resistor and the switch are connected to a positive electrode side of the main power source.

6. The discharge control circuit according to claim 5, further comprising:
a first voltage sensor that detects a voltage of a terminal on the positive electrode side of the series resistor section;
a second voltage sensor that detects a voltage of a connection point between the first resistor and the second resistor; and
a fault diagnosis section that diagnoses a fault of the series resistor section and the switch on the basis of results of detection performed by the first voltage sensor and results of detection performed by the second voltage sensor.

7. The discharge control circuit according to claim 1, further comprising:
a first voltage sensor that detects a voltage of a terminal on the positive electrode side of the series resistor section;
a second voltage sensor that detects a voltage of a connection point between the first resistor and the second resistor; and
a fault diagnosis section that diagnoses a fault of the series resistor section and the switch on the basis of results of detection performed by the first voltage sensor and results of detection performed by the second voltage sensor.

8. The discharge control circuit according to claim 2, further comprising:
a first voltage sensor that detects a voltage of a terminal on the positive electrode side of the series resistor section;
a second voltage sensor that detects a voltage of a connection point between the first resistor and the second resistor; and
a fault diagnosis section that diagnoses a fault of the series resistor section and the switch on the basis of results of detection performed by the first voltage sensor and results of detection performed by the second voltage sensor.
